(19) United States
(12) Patent Application Publication
(10) Pub. No.: US 2018/0012603 A1
(43) Pub. Date: Jan. 11, 2018

(54) SYSTEM AND METHODS FOR PRONUNCIATION ANALYSIS-BASED NON-NATIVE SPEAKER VERIFICATION

(71) Applicants: Julia Komissarchik, Draper, UT (US); Edward Komissarchik, Draper, UT (US)

(72) Inventors: Julia Komissarchik, Draper, UT (US); Edward Komissarchik, Draper, UT (US)

(21) Appl. No.: 15/641,298

(22) Filed: Jul. 4, 2017

Related U.S. Application Data
(60) Provisional application No. 62/359,649, filed on Jul. 7, 2016.

(51) Int. Cl. G10L 17/24; G10L 17/04; G10L 17/02; G10L 17/08; G10L 15/00

(52) U.S. Cl. CPC G10L 17/24; G10L 17/08; G10L 15/005; G10L 17/02; G10L 17/04

(57) ABSTRACT

A system and method for non-native speaker verification based on using N-best speech recognition results.

### FIELD OF THE INVENTION

The present invention relates generally to the field of speaker verification and particularly to a system of verification of non-native speakers and speakers with strong regional accents based on an analysis of their pronunciation patterns.

### BACKGROUND OF THE INVENTION

Voice-based communication with an electronic device (computer, smartphone, car, home appliance) is becoming ubiquitous. With the dramatic growth of voice-enabled devices, the problem of speaker verification has moved to mainstream. Many devices, especially in Internet of Things world, are so small that the only way to communicate with them that is convenient to a human is through voice commands. These devices, typically controlled from a distance, can become a serious security risk, especially by the fact that they are not just sensors that collect data but can execute actions. Voice enabled banking is another big area where speaker authentication is important.

Typical speaker verification system uses the following processes: user enrollment procedure that includes collection of user speech samples for preselected phrases and context data to be used for verification; user verification procedure part A, when a user is asked to pronounce one or several phrases from the list of phrases used during enrollment; and user verification procedure part B, when a user is asked to pronounce one or several new challenge phrases.

The enrollment speech samples are used to extract features from user speech to be compared with features extracted user verification processes. Additionally, recordings of user voice during other interaction with the system can also be used for feature extraction. What features are extracted vary from system to system and can include acoustic, phonetic and prosodic aspects of speech. Context data (e.g. favorite color) can be used to improve imposter detection.

There are two major problem to be addressed in speaker verification: ability to discern an imposter (low false positive rate); and stability (low false negative rate) of recognition of a user across different microphones, noise conditions and different ways a user can speak from one day to another.

The false positive problem is exacerbated by an automatic attack when a recording of user speech is played back to the system. This particular problem is typically addressed by using new phrases in the verification process that were not used during enrollment. The difficulty of using new phrases is that the feature set the system uses to do the verification should be phrase independent, and that is not easy to design. Therefore, some system designers try to build new phrases from the parts of known phrases (see, for example, Google's U.S. Pat. No. 8,812,320). Though potentially this approach can be useful, speech concatenation is quite a complex issue. For example, the mentioned patent uses a challenge word “peanut” based on the enrollment word ‘donut’, and if it does not work uses a challenge word “chestnut”. However transitions from ‘i’ to ‘n’ in ‘peanut’ and ‘t’ to ‘n’ in ‘chestnut’ are quite different than that from ‘o’ to ‘n’ in “donut’ and can cause differences in features used for verification. The use of standalone word ‘nut’ does not solve the problem either, since aspiration at the beginning and at the end of isolated word introduces additional challenges to stable feature extraction.

However, the problem of stability (low false negative rate) is even more challenging. Features extracted from one effort of user pronouncing a phrase can be quite different from features extracted from a different effort to pronounce the same phrase by the same user. Some researchers tried to use certain parameters that can be extracted from speech that indicate anatomical characteristic of user's vocal apparatus, the size of user's head, etc. (see, for example, U.S. Pat. No. 7,016,833). However, the majority of researchers use acoustic, phonetic parameters that are typically used for speech recognition. This is not necessarily the best way, since the purpose of speech recognition is to find out what was said, while the purpose of speaker identification is to find out who said it. The corresponding features thus suffer from ASR “bias” to recognize the phrase and not the speaker. On phonetic (and prosodic) level it leads to use of forced alignment of the phoneme boundaries even if the speaker did not pronounce certain phonemes or pronounced parasitic phonemes, and thus changed the prosodic structure of the utterance. To some extent, the problem of speaker verification is more akin to pronunciation training, since it is interested in not necessarily what was said, but how.

In view of the shortcomings of the prior art, it would be desirable to develop a new approach that can determine certain user speech peculiarities that can be reliably found in user's speech samples and use them to distinguish a legitimate user from an imposter, when, suddenly, what was difficult for a legitimate user to pronounce, was pronounced correctly, and what was easy for a legitimate user to pronounce was pronounced incorrectly.

It further would be desirable to provide a system and methods for detecting such stable patterns and use them to detect if a speaker is a legitimate user or an imposter.

It still further would be desirable to provide a system and method to build challenge phrases for speaker verification that construct challenge phrases based on a particular user's pronunciation peculiarities.

It still further would be desirable to provide a system and methods for speaker verification that can use any third party automatic speech recognition system and work in any language that ASR handles.

It still further would be desirable to provide a system and methods for speaker verification that can perform speaker verification in non-native speaker's mother tongue (L1) with speaker verification in the acquired language (L2).

### SUMMARY OF THE INVENTION

The present invention is a system and method for pronunciation analysis-based speaker verification to distinguish a legitimate user from an imposter.

In view of the aforementioned drawbacks of previously known systems and methods, the present invention provides a system and methods for detecting stable speech patterns of a legitimate user and using these individual speech patterns to build a set of challenge phrases to be pronounced at the speaker verification phase.

This patent looks at the problem of speaker verification from a different angle. It does not assume that user will pronounce phrases correctly, but looks for stable speech patterns that can be reliably expected in user's speech. Incorrect pronunciation of certain words/phrases or phoneme sequences (as soon as it is consistently incorrect) is quite useful to detect an imposter.

The choice of phrase to be used for user enrollment and challenge phrases to be used during verification for non-native speakers is quite different from native speakers. Non-native speakers cannot pronounce certain things that leads to poor recognition results and thus a misrepresentation of speech patterns and features. Furthermore, certain segmentals and suprasegmentals are mispronounced by a non-native speaker differently during several attempts, so they become non-indicative for verification. To avoid high false negative and high false positive rates the system should focus only on stable portions of user's speech. So, for example, in pronunciation of a word ‘bile’ the system could ignore first phoneme and accept ASR result ‘vile’ as correct, if it is said by a person whose first language is Spanish, since the distinction between ‘v’ and ‘b’ does not exist in Spanish.

One of the possibilities in dealing with a non-native speaker is to detect his native tongue (or inquire about his native tongue during enrollment) and then switch to communication in user's native tongue (e.g. from English to Polish). The current state of the art in ASR is such that for some languages there exist much higher quality ASRs than for others. Furthermore, to catch an imposter it is advantageous to also use challenge phrases in user native tongue. It will require collecting some samples in his native tongue during enrollment, but it can provide a drop in false positive rate, since it is much harder to mimic somebody's voice in two different languages.

The approach of this invention is to determine certain user speech peculiarities that can be reliably found in speech samples of a particular user. This approach uses the concept of pronunciation “stars” described in the U.S. Pat. No. 9,076,347 (which is incorporated here by reference). These stars are generated by the analysis of N-best speech recognition results from samples of user speech. There are two major advantages of this approach—it can work with any ASR and it can be used for any language. The methods described in this patent are applicable to the problem of ability to discern an imposter or an automated attack (low false positives) and stability (low false negatives).

The present invention further provides mechanisms to build challenge phrases to be used during speaker verification/authentication that are based on (correct and incorrect) stable speech patterns of a legitimate user.

In accordance with one aspect of the invention, a system and methods for speaker verification/authentication are provided wherein the response of a publicly accessible third party ASR system to user utterances is monitored to detect pronunciation peculiarities of a user.

In accordance with another aspect of the invention, the system and methods for automatic verification of a speaker are provided based on correct and incorrect stable pronunciation patterns of a legitimate user.

In accordance with yet another aspect of the invention, the system can perform speaker verification in L1, L2 or L1 and L2 together.

This invention can be used for verification/authentication of different types of non-native users including ones that have speech impediments or heavy L2 accents.

Though some examples in the Detailed Description of the Preferred Embodiments Invention and in the Drawings are referring to English language, the one skilled in the art will see that the methods of this invention are language independent and can be applied to any language and can be used in any speaker identification system based on any speech recognition engine.

### BRIEF DESCRIPTION OF THE DRAWINGS

Further features of the invention, its nature and various advantages will be apparent from the accompanying drawings and the following detailed description of the preferred embodiments, in which:

FIGS. 1 and 2 are, respectively, a schematic diagram of the system of the present invention comprising software modules programmed to operate on a computer system of conventional design having Internet access, and representative components of exemplary hardware for implementing the system of FIG. 1.

FIG. 3 is a schematic diagram of aspects of an exemplary speech analysis system suitable for use in the systems and methods of the present invention.

FIG. 4 is a schematic diagram of aspects of an exemplary star repository suitable for use in the systems and methods of the present invention.

FIGS. 5a and 5b are schematic diagrams depicting examples of word and phoneme stars from an exemplary embodiment of star repository suitable for use in the systems and methods of the present invention.

FIG. 6 is a schematic diagram of aspects of an exemplary non-native speaker challenge phrase generation system suitable for use in the systems and methods of the present invention.

FIG. 7 is a schematic diagram of aspects of an exemplary verification system suitable for use in the systems and methods of the present invention.

### DETAILED DESCRIPTION OF THE PREFERRED EMBODIMENTS

Referring to FIG. 1, system 100 for pronunciation analysis-based speaker verification is described. System 100 comprises of a number of software modules that cooperate to detect stable pronunciation patterns of a user (correct and incorrect), detect typical errors of ASR for multiple users, build pronunciation pattern-dependent challenge phrases for speaker verification for individual user and for group of users and perform verification of a speaker as a user or as an imposter. Furthermore, these modules work on L1 and L2 in parallel to create additional barrier for imposters.

In particular, system 100 comprises of automatic speech recognition system (“ASR”) 101, utterance repository 102, performance repository 103, star repository 104, speech analysis system 105, star generation system 106, enrollment repository 107, enrollment system 108, challenge phrase repository 109, challenge phrase generation system 110, verification system 111, and human-machine interface component 112.

Methods for some of these systems were introduced in U.S. Pat. No. 9,076,347, patent application Ser. No. 15/587,234, patent application Ser. No. 15/592,946, patent application Ser. No. 15/607,568 and Patent Application 62/359,642 (which are incorporated here by reference).

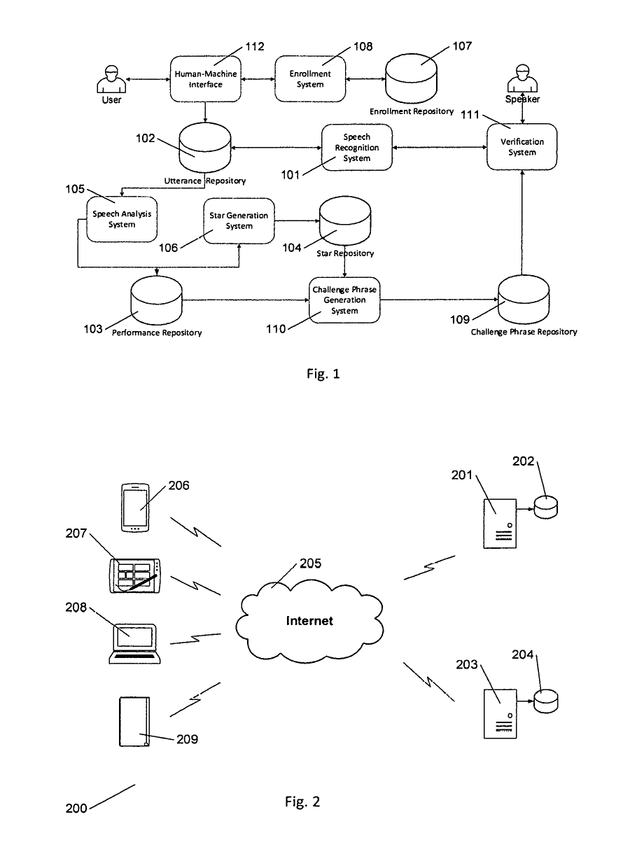

Components 101-112 may be implemented as a standalone system capable of running on a single personal computer. More preferably, however, components 101-112 are distributed over a network, so that certain components, such as repositories and systems 102-111 and ASR 101 reside on servers accessible via the Internet. FIG. 2 provides one such exemplary embodiment of system 100, wherein repositories and systems 102-111 may be hosted by the provider of pronunciation analysis-based speaker verification software on server 201 including database 202, while ASR system 101, such as Google Voice system, is hosted on server 203 including database 204. Servers 201 and 203 are coupled to Internet 205 via known communication pathways, including wired and wireless networks.

A user using the inventive system and methods of the present invention may access Internet 205 via mobile phone 206, via tablet 207, via personal computer 208, or via speaker verification control box 209. Human-machine interface component 112 preferably is loaded onto and runs on mobile devices 206 or 207 or computer 208, while utterance repository 102, performance repository 103, star repository 104, speech analysis system 105, star generation system 106, enrollment repository 107, enrollment system 108, challenge phrase generation system 110 may operate on server side (i.e., server 201 and database 202 correspondingly), while challenge phrase repository 109 and verification system 111 may operate on server side together with ASR 101 (i.e. database 204 and server 203 correspondingly) , depending upon the complexity and processing capability required for specific embodiments of the inventive system.

Each of the foregoing subsystems and components 101-112 are described below.

Automatic Speech Recognition System (ASR)

The system can use any ASR. Though multiple ASRs can be used in parallel to process user's speech, typical configuration consists of just one ASR. A number of companies (e.g. Google, Nuance and Microsoft) have good ASRs that are used in different tasks spanning voice assistance, IVR, web search, navigation, voice commands. Most ASRs have Application Programming Interfaces (API) that provide details of the recognition process including alternative recognition results (so called N-Best list) and in some cases acoustic features of the utterances spoken. Recognition results provided through API in many cases are associated with weights that show level of confidence that ASR has in each particular alternative.

All the aforementioned ASR's are speaker independent, which means that they can recognize any speaker. The quality of recognition however depends heavily on whether a speaker is “mainstream” or has a regional accent. There exist mechanisms for speaker adaptation that do additional training of ASR on speech samples of a particular user. These mechanisms are useful in applications like dictation; however, they require a significant number of samples to get trained, which is normally not applicable to speaker verification applications. For non-native speakers the situation is significantly more aggravated. For non-native speakers ASR's typically demonstrate significant drop in quality of recognition. This creates a serious challenge for non-native speaker verification systems. Specific methods of dealing with the problems are required to avoid ASR pitfalls while still preserving the ability to verify non-native speakers. These methods are described in the chapters below.

Utterance Repository

Utterance repository 102 contains users' utterances and ASR results. This repository is used to store utterances collected during user enrollment, as well as the ones user uttered during verification. For the latter, they are stored only if the verification process confirmed the identity of the user. Additionally, in some cases other samples of user speech are available. For the detailed description of this repository, see Patent Application 62/359,642.

Utterance Repository can contain utterances in L1 (first language or native tongue) and L2 (second language or acquired tongue).

Performance Repository

Performance Repository 103 contains historical and aggregated information on user pronunciation. This repository is used to determine patterns of user pronunciation to be used at speaker verification stage. Stable patterns that can be indicative for verification are stored in the star repository 104.

For the detailed description of this repository, see Patent Application 62/359,642.

Star Repository

Stars were introduced in the U.S. Pat. No. 9,076,347 mentioned above. Star is a structure that consists of a central node and a set of periphery nodes connected to the central node. Central node contains phoneme, sequence of phonemes, word or phrase that was supposed to be pronounced. Periphery nodes contain ASR recognition of pronunciation of the central node by a user or a group of users. Stars contain aggregate knowledge about user pronunciation patterns, and are used to check if user pronunciation during verification stage matches these patterns.

Not all stars that would work fine for native speakers can be useful for verification of non-native speakers. Non-native speakers with the same L1 (mother tongue) demonstrate similar errors speaking in L2 (second language). These errors introduce noise into the speaker verification process, since similar results are common for a group of speakers and cannot be used to differentiate between them. Star Pruning Algorithm is designed to eliminate such noise from the star repository 104.

Speech Analysis System

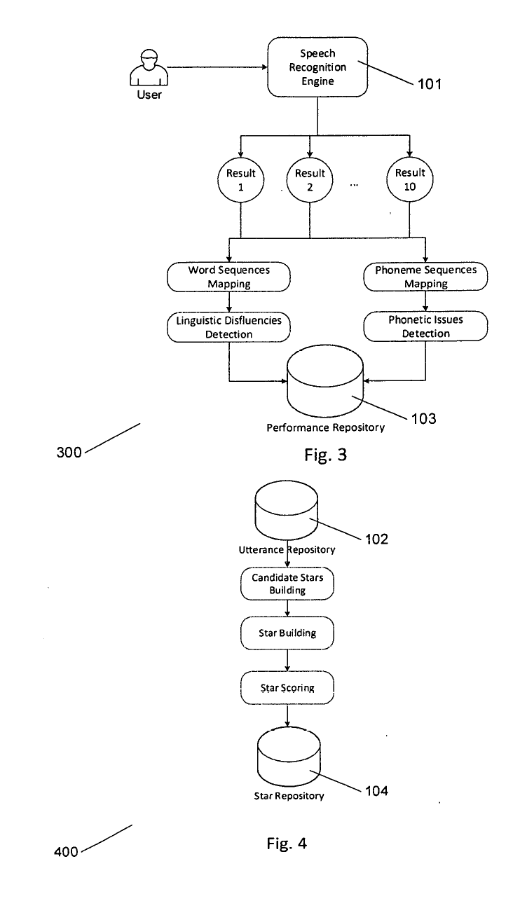

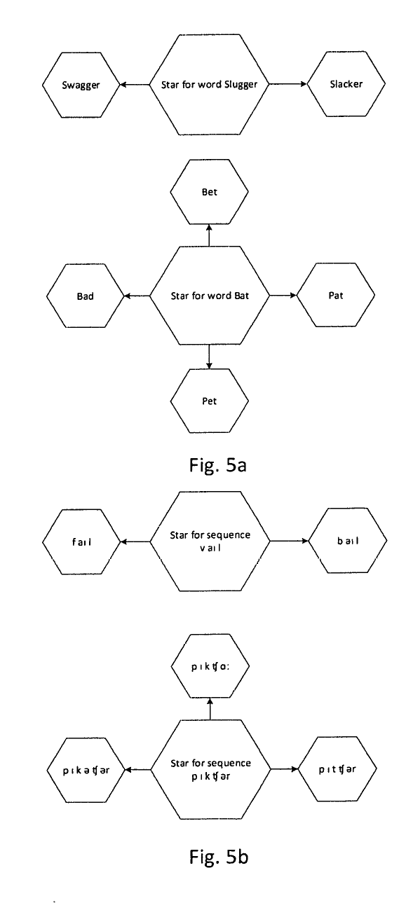

Referring now to FIG. 3, the speech analysis system 105 analyses ASR results. This system analyses ASR results both in cases, when it is unknown what phrase was pronounced or supposed to be pronounced by a user (Unsupervised Analysis) and in cases, when a user is supposed to pronounce a phrase from a predefined list (Supervised Analysis). The unsupervised situation is atypical for speaker verification system. However, if a set of prerecorded user utterances is available it can be applied. For detailed description of both unsupervised and supervised speech analysis, see patent application Ser. No. 15/587,234.

Star Generation System

Referring now to FIG. 4, the star generation system 105 uses performance repository 103 to find sequences of phonemes, words and phrases that have homogeneous N-best results in multiple occurrences in one utterance and across multiple utterances. While in U.S. Pat. No. 9,076,347 the central node of a star contained a word or a phrase, in this patent it can also be a sequence of phonemes. The results are stored in the star repository 104. The stars for a particular user are updated when utterance repository 102 gets additional utterances from that user.

For non-native speakers certain stars are not useful since they represent common errors for speakers with the same L1, and thus not only cannot differentiate speakers from these groups but introduce noise in verification process. These stars are removed from the star repository 104 as described in the star pruning algorithm.

Star Building Algorithm

Star Building Algorithm takes an utterance in the utterance repository 102 the ASR N-best results and using algorithms from the word matching and the phoneme matching subsystems of the speech analysis system 105 builds a star. For more details, see Patent Application 62/359,642.

Star Pruning Algorithm

Star Pruning Algorithm is applied on a regular basis to the star repository 104. The first step is to build clusters of stars with the same phrase (or sequence of phonemes) in their central node that belong to users with the same L1. If there are more than a certain threshold number (or percentage) of stars that have the same high confidence rays then these stars are marked as ‘noisy” and are no longer used in verification process. They are still preserved in the repository to be used later in clustering at the next iteration of the algorithm when new stars are added to the star repository 104.

Enrollment Repository

The enrollment repository 107 contains information about phrases to be used for the enrollment process. This repository also can contain context information that can be used for user verification. That includes information such as favorite pet, favorite color, or things like native tongue or mother's maiden name. For more details, see Patent Application 62/359,642. For non-native speakers the repository can also contain phrases in user's L1.

Enrollment System

Enrollment system 108 is designed to collect user pronunciation samples, and extract features to be used during verification when user tries to access different applications using voice-based interface. Since in many cases enrollment is done through voice communication with the user, enrollment system could also use additional data elements such as last four digits of SSN, date of birth, or mother's maiden name. These data elements could be either collected during enrollment or inputted from other systems. The latter case is typical for voice-enabled banking.

L1 (mother tongue) of a non-native speaker can be collected during enrollment. To increase the reliability of speaker verification for non-native speakers, enrollment should include collection of voice samples pronounced in L1.

Challenge Phrase Repository

Challenge phrase repository 109 contains phrases that are used during speaker verification. These phrases are presented to a speaker and then the results are matched against the stored profiles of the speaker (see the description of verification system 111 below). Though the same phrase can be used for multiple speakers (as what typically is done by speaker verification systems), the more robust approach is to use phrases that are tuned to individual speaker pronunciation peculiarities (see the description of challenge phrase generation system 110 below). The presence of these peculiarities is an indicator that the speaker is not an imposter, while their absence is an indicator of a potential imposter. An interesting phenomenon is that the opposite is also true. If in pronouncing a challenge phrase a speaker utterance have peculiarities that were not present during enrollment, then it is an indicator for this speaker being an imposter.

For non-native speakers the choice of challenge phrases should reflect the fact that non-native speakers most likely have some variability in mispronunciation of the same phrase during different attempts. The variability grows with the length of the phrase since the longer the phrase the more places are in it for “slippage”.

The same is true for complex phoneme sequences, especially clusters of 3 consonants or complex phoneme transitions like ‘ts’. These complex sequences are different for non-native speaker with different mother tongues. For example, for an Armenian or a Czech speaker to pronounce 3 or even 4 consonants in a row is not a big deal, while for a Japanese speaker even 2 consonants in a row might constitute a problem, since in Japanese consonants are separated by vowels.

Challenge Phrase Generation System

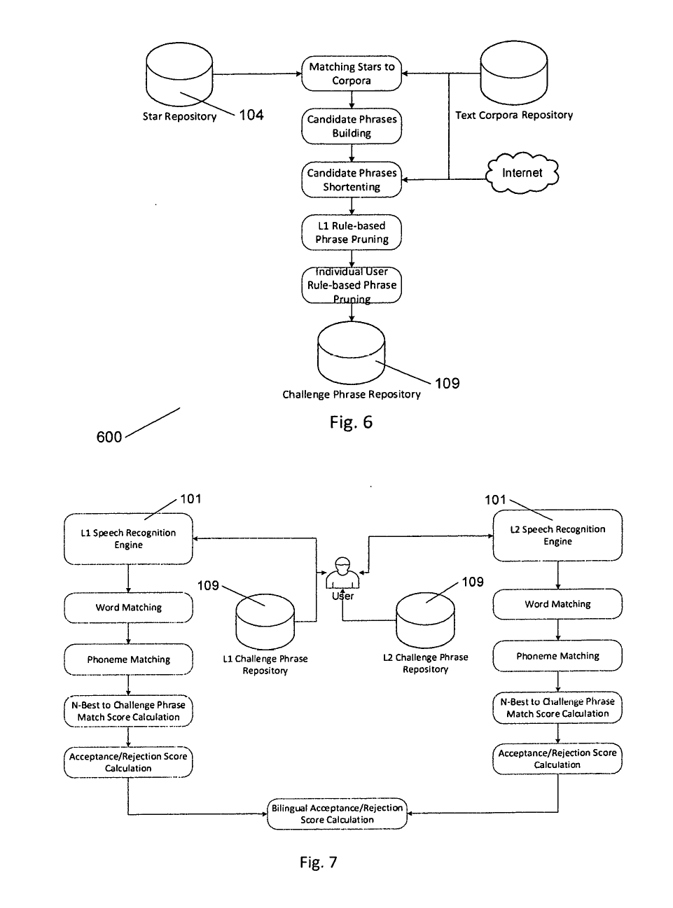

Referring now to FIG. 6, non-native speaker challenge phrase generation system 110 builds phrases to he used during speaker verification. For each user it creates two sets of challenge phrases. Type 1-phrases that are similar to the central nodes in the stars for this user from the star repository 104 which have no more than 2 rays with weights above certain threshold. And Type 2-phrases that are similar to the central nodes in the stars from the star repository 104 that have 5 or more rays above that threshold. The first set is used to verify that the user can still pronounce well what he could pronounce during enrollment (or during other times of talking, for example, to an IVR), while the second one is used to detect an imposter if these phrases suddenly started to be well recognized. The results are stored in the challenge phrase repository 109. The results for a particular user are updated when the utterance repository 102 gets additional utterances from that user.

Non-Native Speaker Challenge Phrase Generation Algorithm

The first step is to build a set of candidate phrases using challenge phrase generation algorithm described in Patent Application 62/359,642.

The second step is to apply rules specific to an individual user or a group of users such as speakers with the same L1. Typical pronunciation peculiarities of non-native speakers with the same L1 talking in L2 such as consonant sequences mentioned above were studied by phoneticians for many years. Another large set of typical pronunciation peculiarities is minimal pairs (see U.S. Pat. No. 9,076,347). The rules associated with these groups are applied to eliminate phrases that by being typically mispronounced are not good for verification.

The individual peculiarities are built using phoneme level comparison of stars corresponding to a particular user. (see challenge phrase generation algorithm described in Patent Application 62/359,642).

Each challenge phrase in challenge phrase repository is associated with the type of the rules applicable to it and the score.

Verification System

Referring now to FIG. 7, verification system 111 uses challenge phrases of both type 1 and type 2 from the challenge phrases repository 109 corresponding to a particular user (or a category of users this user belongs to) and through user interface (see the description of human-machine interface system 112 below) asks a speaker (that pretends to be this user) to pronounce one or several phrases.

For each utterance, the results of recognition are compared with the stars corresponding to the pronounced phrase. The results are matched to the stars (see challenge phrase pronunciation scoring algorithm described in Patent Application 62/359,642) and a match score is recorded. These is done for Type 1 and Type 2 separately. The high score for a challenge phrase of Type 1 is a sign that the speaker is not an imposter, while high score for Type 2 is a sign that he is. Depending on each score and thresholds used in the definition of the term ‘high’ for each type, one or several more challenge sentences might be needed to decide if the speaker is the user he claims to be. The challenge phrases can be chosen based on their scores starting with the ones that have higher score.

Human-Machine Interface System

The human-machine interface system 112 is designed to facilitate communication between a user and the system. The system 112 can additionally use non-voice communication if the interaction setup provides for that (e.g. in case of a kiosk). However, for the speaker identification purposes the system can be configured to use just voice. In many cases, enrollment process can include non-voice communication, while verification process is typically voice only.

One of the possible configurations can include IVR which is de facto today's standard of consumers communication with companies. The static portion of interaction (greetings and instruction phrases) are usually pre-recorded and use human voice to make interaction more pleasant. For dynamic part of the interaction, the system uses text-to-speech. This is especially important for challenge phrases since they can be completely arbitrary.

The system 112 is also used to convey the situation to a customer representative in cases of suspicious/unstable speaker or ASR behavior. The latter is a typical feature of existing IVRs.

What is claimed is:

1. A system for creating pronunciation analysis-based non-native speaker verification comprising of:
a speech recognition system that analyzes an utterance spoken by the user in user's mother tongue (L1) and user's acquired tongue (L2) and returns a ranked list of recognized phrases;
a speech analysis module that analyzes a list of recognized phrases and determines the parts of utterances that were pronounced in L1 and/or L2 correctly and the parts of utterances that were mispronounced;
a star repository that contains star-like structures with the central node corresponding to a sequence of words or phonemes to be pronounced and the periphery nodes corresponding to results of ASR of pronunciation of the central node by a user or a group of users for L1 and/or L2;
a star generation system that finds sequences of phonemes, words and phrases in L1 and/or L2 that have homogeneous N-best results in multiple occurrences in one utterance and across multiple utterances for a user or a group of users and stores the results in a star repository;
a challenge phrase generation system that builds a set of phrases in L1 and/or L2 to be used to detect if a speaker is a legitimate user or an imposter using large text corpora or internet at large to find phrases that correspond to stars that are consistently well recognized and stars that are consistently poorly recognized;
a speaker verification system that uses challenge phrases in L1 and/or L2 to verify that the phrases that are consistently well recognized for a user continue to be well recognized during verification/authentication of a speaker, and the ones that were consistently were mispronounced by a user are mispronounced during verification/authentication phase; and
a human-machine interface that facilitates user registration and speaker verification phases.

2. The system of claim 1 where users' L1 and/or L2 utterances are stored in an utterance repository accessible via the Internet.

3. The system of claim 1, further comprising a performance repository accessible via the Internet, wherein users' L1 and/or L2 mispronunciations and speech peculiarities are stored corresponding to their types.

4. The system of claim 1, further comprising a speech analysis system that stores users' L1 and/or L2 mispronunciations and speech peculiarities in a performance repository accessible via the Internet.

5. The system of claim 1, further comprising a star repository that contains stars consisting of central node containing a sequence of words or phonemes to be pronounced and periphery nodes corresponding to ASR results of central nodes pronounced by users.

6. The system of claim 1, further comprising of a star generation system that builds stars in L1 and/or L2 using an utterance repository and stores them in a star repository accessible via the Internet.

7. The system of claim 1, further comprising of a challenge phrase generation system that uses star repository and other data sources including Internet at large for L1 and/or L2 to build phrases that will be consistently recognized or consitently misrecognized by ASR to be used to detect an imposter at the speaker verification phase, and storing these phrases in a challenge phrase repository available via the Internet.

8. The system of claim 1, further comprising a verification system that offers to a speaker challenge phrases in L1 and/or L2 from a challenge repository and scores the results for verification based on comparing stable patterns (correct and incorrect) of a user and a speaker that is being verified.

9. The system of claim 1, wherein a speech recognition system is accessible via the Internet.

10. The system of claim 9, wherein a speech recognition system comprises a publicly available third-party speech recognition system.

11. The system of claim 1 wherein a human-machine interface is configured to operate on a mobile device.

12. A method for creating pronunciation analysis-based non-native speaker verification comprising of:
analyzing user utterances using a speech recognition system, the speech recognition system returning a ranked list of recognized phrases;
using the ranked lists of recognition results to build user's pronunciation profile consisting of user's L1 and/or L2 mispronunciations and speech peculiarities organized by types;
using the Internet, large text corpora and other sources to build challenge phrases for L1 and/or L2 that match user pronunciation profile in correct and incorrect pronunciation that are consistently recognized or correspondingly misrecognized by an ASR; and
using the built challenge phrases in L1 and/or L2 at the verification phase to detect if a speaker is a legitimate user or an imposter.

13. The method of claim 12, further comprising accessing a speech recognition system via the Internet.

14. The method of claim 13, wherein accessing a speech recognition system via the Internet comprises accessing a publicly available third-party speech recognition system.

15. The method of claim 12, wherein the communication with the user is performed using a mobile device.
